(19) United States
(12) Patent Application Publication
(10) Pub. No.: US 2016/0315370 A1
(43) Pub. Date: Oct. 27, 2016

(54) TELESCOPIC ANTENNA DEVICE

(71) Applicant: TRANS ELECTRIC CO., LTD., Changhua (TW)

(72) Inventor: Ken CHIANG, Changhua (TW)

(21) Appl. No.: 14/829,683

(22) Filed: Aug. 19, 2015

(30) Foreign Application Priority Data
Apr. 27, 2015 (TW) 104206385

(51) Int. Cl. H01Q 1/10; H01Q 1/12

(52) U.S. Cl. CPC H01Q 1/10; H01Q 1/1235

(57) ABSTRACT

An antenna device includes a casing unit and an antenna unit. The casing unit includes a main casing, and two auxiliary casings each of which projects movably from a respective one of two opposite ends of the main casing. The antenna unit includes a main antenna module disposed in the main casing, and two auxiliary antenna modules respectively disposed in the auxiliary casings. Each of the auxiliary antenna modules has a contact point electrically coupled to the main antenna module, and a fixing point fixed to a corresponding one of the auxiliary casings such that, when each of the auxiliary casings is moved from a retracted position to an extended position relative to the main casing, a total length of the antenna unit along the axis is increased.

### CROSS-REFERENCE TO RELATED APPLICATION

This application claims priority of Taiwanese Application No. 104206385, filed on Apr. 27, 2015.

### FIELD

The disclosure relates to an antenna device, and more particularly to a telescopic antenna device.

### BACKGROUND

Generally, an antenna is for receiving signals in a certain frequency range, for example, from 470 Mhz to 860 Mhz. Theoretically, the antenna that is capable of receiving a signal having a frequency of 470 Mhz has a length of about 32 centimeters. Such antenna may be configured as a telescopic rod for the consideration of delivery and storage thereof. However, an exposed telescopic rod may be dangerous and is not visually aesthetic.

### SUMMARY

Therefore, an object of the disclosure is to provide an antenna device that can overcome at least one of the aforesaid drawbacks associated with the prior arts.

According to the disclosure, the antenna device includes a casing unit and an antenna unit. The casing unit includes a main casing, and two auxiliary casings each of which projects from a respective one of two opposite ends of the main casing along an axis and is movable relative to the main casing along the axis between an extended position and a retracted position. The antenna unit includes a main antenna module that is disposed in the main casing, and two auxiliary antenna modules that are respectively disposed in the auxiliary casings. Each of the auxiliary antenna modules has at least one contact point at an end thereof that is electrically coupled to the main antenna module, and at least one fixing point at an opposite end thereof that is fixed to a corresponding one of the auxiliary casing such that, when at least one of the auxiliary casings is moved from the retracted position to the extended position, a total length of the antenna unit along the axis is increased.

### BRIEF DESCRIPTION OF THE DRAWINGS

Other features and advantages of the disclosure will become apparent in the following detailed description of the embodiments with reference to the accompanying drawings, of which:

FIG. 1 is a partly exploded perspective view of a first embodiment of an antenna device according to the disclosure;

FIG. 2 is another partly exploded perspective view of the first embodiment, illustrating two auxiliary antenna modules being shortened;

FIG. 3 is a partly exploded perspective view of a second embodiment of the antenna device according to the disclosure;

FIG. 4 is another partly exploded perspective view of the second embodiment, illustrating two auxiliary antenna modules being flexed;

FIG. 5 is a partly exploded perspective view of a third embodiment of the antenna device according to the disclosure;

FIG. 6 is another partly exploded perspective view of the third embodiment, illustrating two auxiliary antenna modules being flexed;

FIG. 7 is a perspective view of the antenna device according to the disclosure, illustrating the antenna device being extended; and

FIG. 8 is another perspective view of the antenna device according to the disclosure, illustrating the antenna device being retracted.

### DETAILED DESCRIPTION

Before the disclosure is described in greater detail, it should be noted that like elements are denoted by the same reference numerals throughout the disclosure.

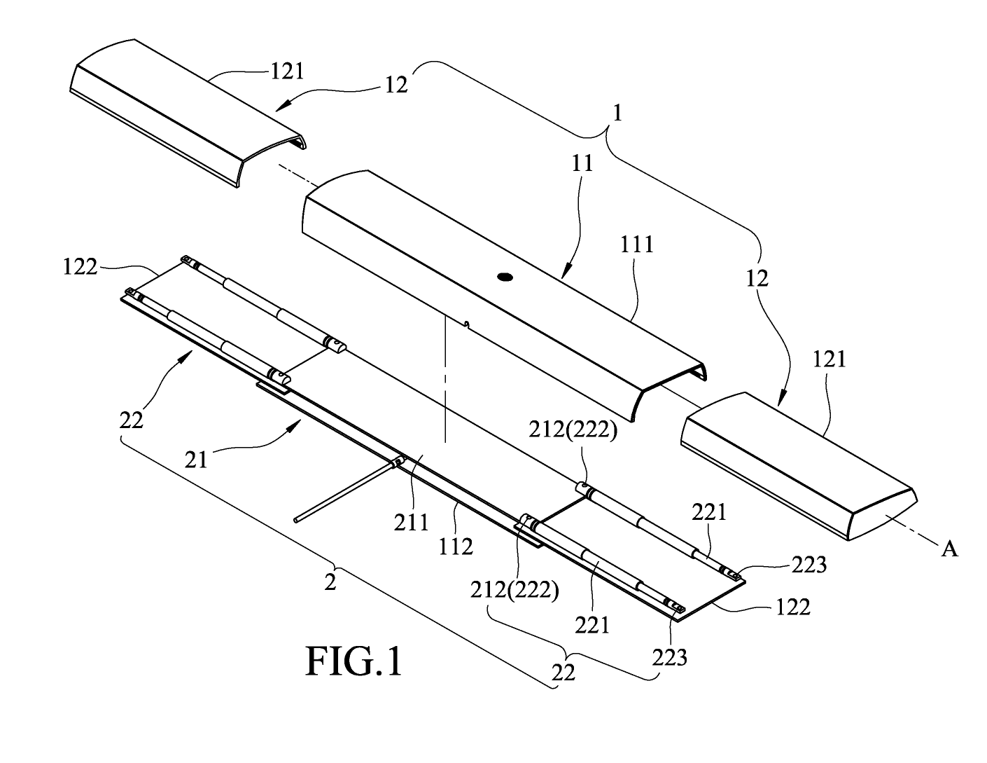

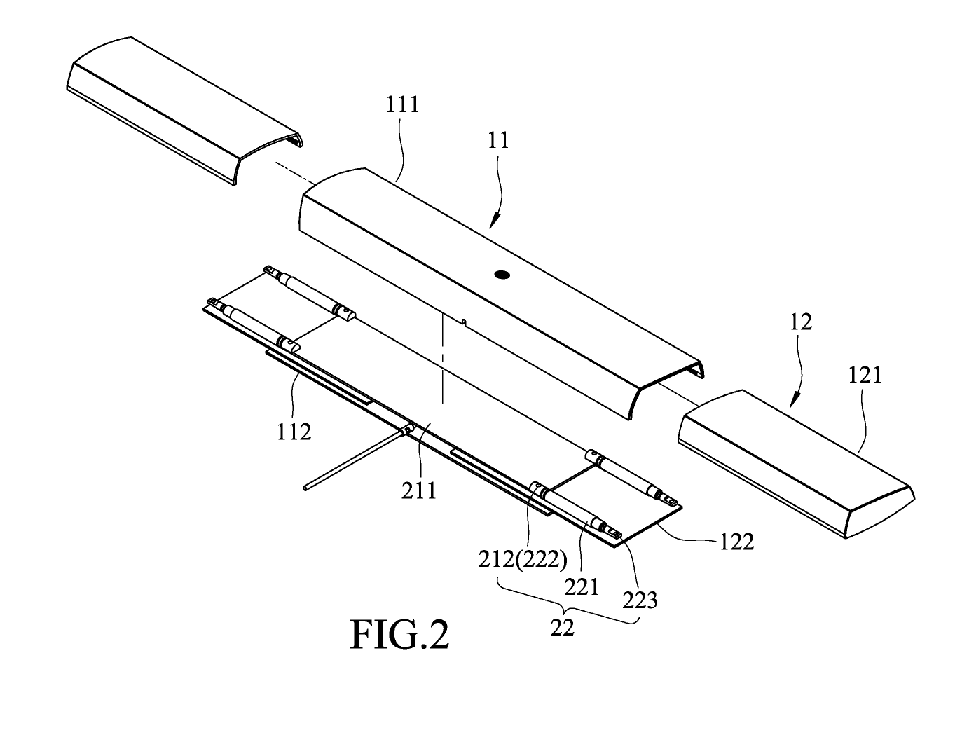

Referring to FIGS. 1 and 2, a first embodiment of an antenna device according to the disclosure includes a casing unit 1 and an antenna unit 2.

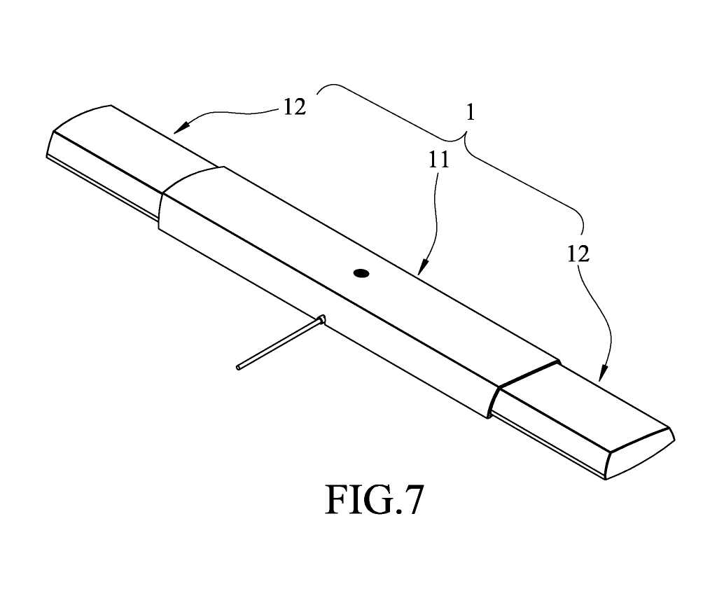

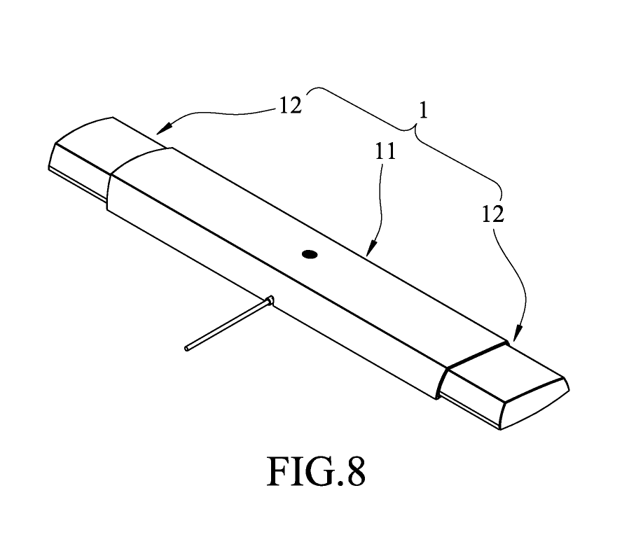

The casing unit 1 includes a main casing 11, and two auxiliary casings 12 that respectively project from two opposite ends of the main casing 11 along an axis (A). Each of the auxiliary casings 12 is movable relative to the main casing 11 along the axis (A) between an extended position (see FIGS. 1 and 7) and a retracted position (see FIGS. 2 and 8). In this embodiment, the main casing 11 includes assembled upper and lower pieces 111, 112. Each of the auxiliary casings 12 includes assembled upper and lower pieces 121, 122.

The antenna unit 2 includes a main antenna module 21 that is disposed in the main casing 11, and two auxiliary antenna modules 22 that are respectively disposed in the auxiliary casings 12. The main antenna module 21 includes a rectangularly-shaped main circuit board 211 that has a plurality of contact points 212. Each of the auxiliary antenna modules 22 includes two telescopic antenna rods 221. Each of the antenna rods 221 of the auxiliary antenna modules 22 has opposite ends respectively serving as a contact point 222 and a fixing point 223.

In this embodiment, the main circuit board 211 of the main antenna module 21 has four contact points 212 that are respectively located at four corners of the main circuit board 211. Each of the contact points 212 of the main circuit board 211 is electrically coupled to the contact point 222 of a respective one of the antenna rods 221 of the auxiliary antenna modules 22 for increasing the bandwidth of the antenna unit 2. The lower piece 122 of each of the auxiliary casings 12 is fixed to the fixing points 223 of the antenna rods 221 of a corresponding one of the auxiliary antenna modules 22. The antenna rods 221 of each of the auxiliary antenna modules 22 are spaced apart from each other in a direction perpendicular the axis (A), so that each of the auxiliary casings 12 is able to move smoothly relative to the main casing 11.

When each of the auxiliary casings 12 is at the retracted position (see FIGS. 2 and 8), the antenna rods 221 of each of the auxiliary antenna modules 22 are shortened, and the antenna device therefore has a relatively small total length along the axis (A) for facilitating the delivery and storage thereof. When each of the auxiliary casings 12 is moved from the retracted position to the extended position (see FIGS. 1 and 7), the fixing points 223 of the antenna rods 221 of each of the auxiliary antenna modules 22 are drawn by the corresponding one of the auxiliary casings 12 to move away from the main antenna module 21 so as to elongate the antenna rods 221 of the corresponding one of the auxiliary antenna modules 22 for increasing the total length of the antenna device along the axis (A) in order to receive a signal having a relatively low frequency.

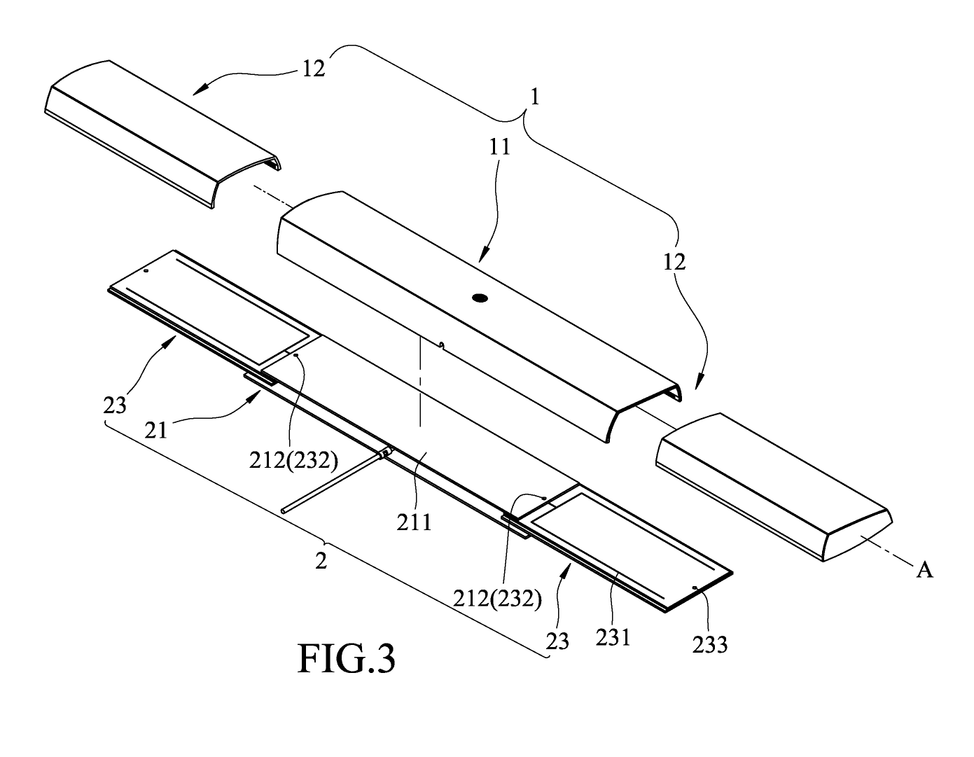

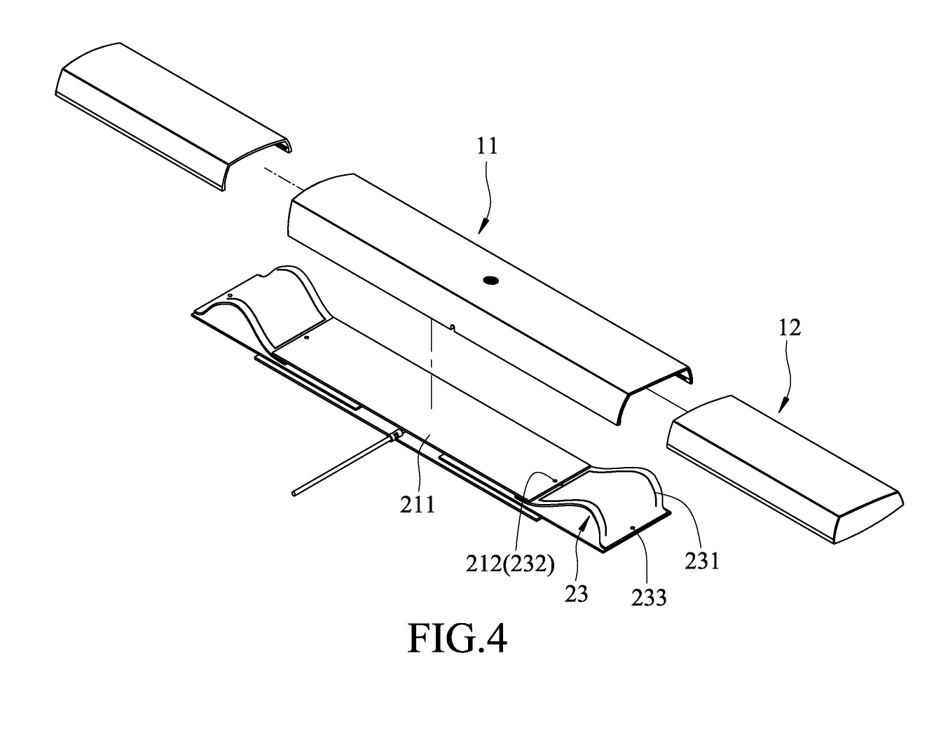

Referring to FIGS. 3 and 4, a second embodiment of the antenna device according to the disclosure includes a casing unit 1 that is the same as that of the first embodiment, and an antenna unit 2.

The antenna unit 2 includes a main antenna module 21 that is disposed in the main casing 11, and two auxiliary antenna modules 23 that are respectively disposed in the auxiliary casings 12. The main antenna module 21 includes a rectangularly-shaped main circuit board 211 that has a plurality of contact points 212. Each of the auxiliary antenna modules 23 is configured as a flexible circuit board that has an antenna circuit 231 provided with a contact point 232, and a fixing point 233 located at an end thereof distal from the main antenna module 21 and fixed to a corresponding one of the auxiliary casings 12.

In this embodiment, the main circuit board 211 of the main antenna module 21 has two contact points 212 that are respectively located at two opposite ends of the main circuit board 211 along the axis (A). Each of the contact points 212 of the main circuit board 211 is electrically coupled to the contact point 232 of the antenna circuit 231 of a respective one of the auxiliary antenna modules 23 for increasing the bandwidth of the antenna unit 2.

When each of the auxiliary casings 12 is at the retracted position (see FIGS. 4 and 8), each of the auxiliary antenna modules 23 is flexed, and the antenna device therefore has a relatively small total length along the axis (A). When each of the auxiliary casings 12 is moved from the retracted position to the extended position (see FIGS. 3 and 7), the fixing point 233 of each of the auxiliary antenna modules 23 are drawn by the corresponding one of the auxiliary casings 12 to move away from the main antenna module 21 so that the corresponding one of the auxiliary antenna modules 22 is flat for increasing the total length of the antenna device along the axis (A).

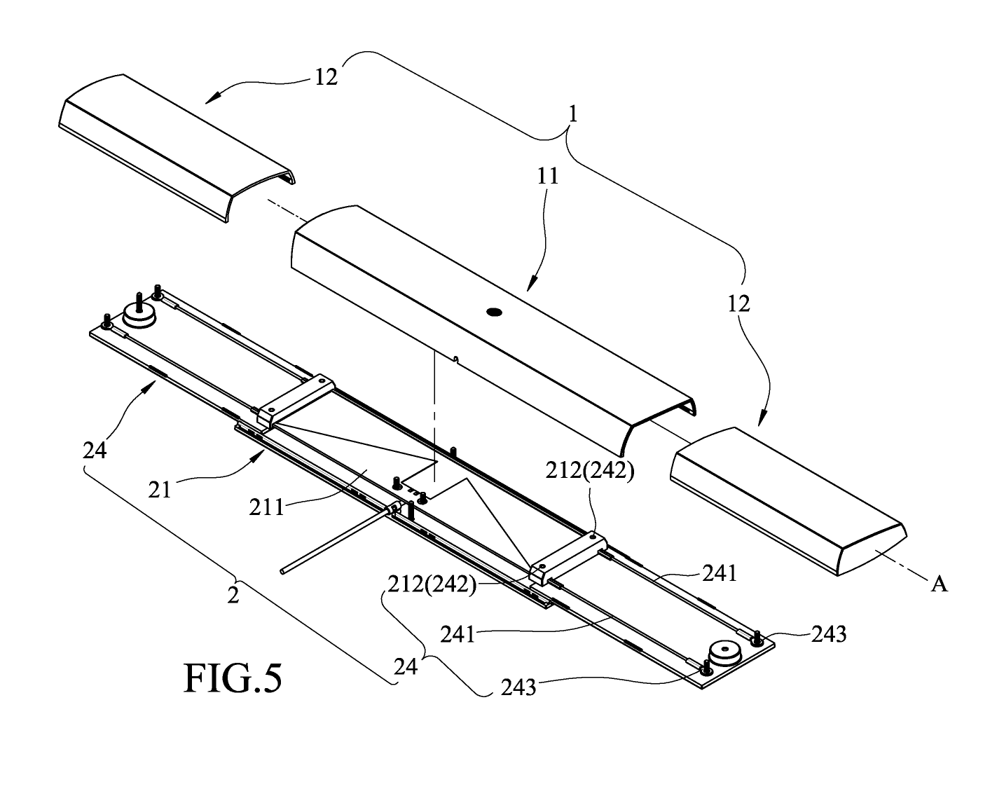

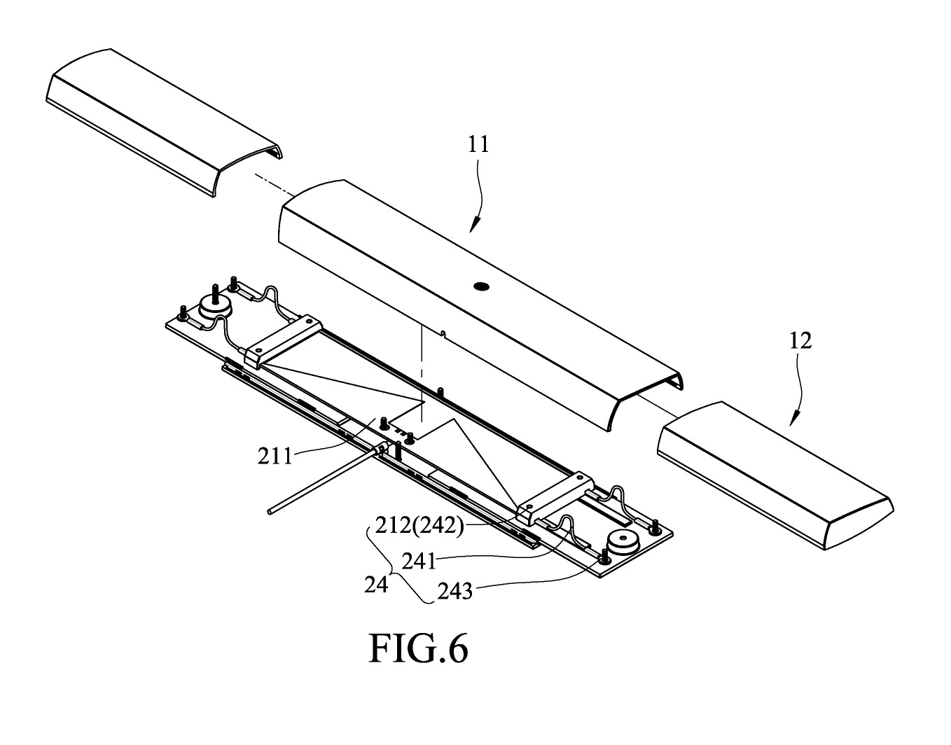

Referring to FIGS. 5 and 6, a third embodiment of the antenna device according to the disclosure includes a casing unit 1 that is the same as that of the first embodiment, and an antenna unit 2.

The antenna unit 2 includes a main antenna module 21 that is disposed in the main casing 11, and two auxiliary antenna modules 24 that are respectively disposed in the auxiliary casings 12. The main antenna module 21 includes a rectangularly-shaped main circuit board 211 that has a plurality of contact points 212. Each of the auxiliary antenna modules 24 includes two flexible wire antennas 241. Each of the wire antennas 241 of the auxiliary antenna modules 24 has opposite ends respectively serving as a contact point 242 and a fixing point 243. In this embodiment, the main circuit board 211 of the main antenna module 21 has four contact points 212 that are respectively located at four corners of the main circuit board 211. Each of the contact points 212 of the main circuit board 211 is electrically coupled to the contact point 242 of a respective one of the wire antennas 241 of the auxiliary antenna modules 24 for increasing the bandwidth of the antenna unit 2. The lower piece 122 of each of the auxiliary casings 12 is fixed to the fixing points 243 of the wire antennas 241 of a corresponding one of the auxiliary antenna modules 24.

When each of the auxiliary casings 12 is at the retracted position (see FIGS. 6 and 8), the wire antennas 241 of each of the auxiliary antenna modules 24 are flexed, and the antenna device therefore has a relatively small total length along the axis (A). When each of the auxiliary casings 12 is moved from the retracted position to the extended position (see FIGS. 5 and 7), the fixing points 243 of the wire antennas 241 of each of the auxiliary antenna modules 24 are drawn by the corresponding one of the auxiliary casings 12 to move away from the main antenna module 21 so that the wire antennas 241 of the corresponding one of the auxiliary antenna modules 24 are flat for increasing the total length of the antenna device along the axis (A).

To sum up, since the antenna unit 2 is enclosed within the casing unit 1, the antenna device of this disclosure is visually aesthetic and is safe in the use thereof.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. An antenna device comprising:
a casing unit including a main casing, and two auxiliary casings each of which projects from a respective one of two opposite ends of said main casing along an axis and is movable relative to said main casing along the axis between an extended position and a retracted position; and
an antenna unit including a main antenna module that is disposed in said main casing, and two auxiliary antenna modules that are respectively disposed in said auxiliary casings, each of said auxiliary antenna modules having at least one contact point at an end thereof that is electrically coupled to said main antenna module, and at least one fixing point at an opposite end thereof that is fixed to a corresponding one of said auxiliary casings such that, when at least one of said auxiliary casings is moved from the retracted position to the extended position, a total length of said antenna unit along the axis is increased.

2. The antenna device as claimed in claim 1, wherein said main antenna module includes a main circuit board that has a plurality of contact points, said contact points of said circuit board being respectively and electrically coupled to said contact points of said auxiliary antenna modules.

3. The antenna device as claimed in claim 2, wherein each of said auxiliary antenna modules includes at least one telescopic antenna rod that has opposite ends respectively serving as said contact point and said fixing point of a corresponding one of said auxiliary antenna modules, said antenna rod of each of said auxiliary antenna modules being shortened when the corresponding one of said auxiliary casings is at the retracted position, and being elongated when the corresponding one of said auxiliary casings is at the extended position.

4. The antenna device as claimed in claim 3, wherein each of said auxiliary antenna modules includes a plurality of said antenna rods that are spaced apart from each other in a direction perpendicular to the axis and that are coupled to said main circuit board.

5. The antenna device as claimed in claim 4, wherein each of said auxiliary antenna modules includes two said antenna rods, said main circuit board of said main antenna module being rectangularly-shaped, and having four said contact points that are respectively located at four corners thereof and that are respectively and electrically coupled to said antenna rods of said auxiliary antenna modules.

6. The antenna device as claimed in claim 1, wherein each of said auxiliary antenna modules is configured as a circuit board that has an antenna circuit provided with said contact point and that has said fixing point, each of said auxiliary antenna modules being flexed when a corresponding one of said auxiliary casings is at the retracted position, and being flat when the corresponding one of said auxiliary casings is at the extended position.

7. The antenna device as claimed in claim 1, wherein each of said auxiliary antenna modules includes at least one flexible wire antenna that has opposite ends respectively serving as said contact point and said fixing point of a corresponding one of said auxiliary antenna modules, said wire antenna of each of said auxiliary antenna modules being flexed when the corresponding one of said auxiliary casings is at the retracted position, and being flat when the corresponding one of said auxiliary casings is at the extended position.

8. The antenna device as claimed in claim 7, wherein each of said auxiliary antenna modules includes a plurality of said wire antennas that are spaced apart from each other in a direction perpendicular to the axis and that are coupled to said main circuit board.

9. The antenna device as claimed in claim 8, wherein each of said auxiliary antenna modules includes two said wire antennas, said main circuit board of said main antenna module being rectangularly-shaped, and having four said contact points that are respectively located at four corners thereof and that are respectively and electrically coupled to said wire antennas of said auxiliary antenna modules.
